(19) United States
(12) Patent Application Publication
(10) Pub. No.: US 2025/0045955 A1
(43) Pub. Date: Feb. 6, 2025

(54) INFORMATION PROCESSING APPARATUS, INFORMATION PROCESSING METHOD, AND COMPUTER-READABLE RECORDING MEDIUM

(71) Applicant: NEC Corporation, Tokyo (JP)

(72) Inventor: Gaku NAKANO, Tokyo (JP)

(73) Assignee: NEC Corporation, Tokyo (JP)

(21) Appl. No.: 18/788,272

(22) Filed: Jul. 30, 2024

(30) Foreign Application Priority Data
Aug. 4, 2023 (JP) 2023-128099

(51) Int. Cl. G06T 7/73; G06T 5/60; G06T 5/70; G06T 7/50

(52) U.S. Cl. CPC G06T 7/74; G06T 5/60; G06T 5/70; G06T 7/50; G06T 2207/10028; G06T 2207/20081; G06T 2207/30244

(57) ABSTRACT

An information processing apparatus includes an image generating unit that generates, based on a camera position of a query image that is obtained by shooting a scene by a camera from the camera position, and three dimensional information regarding the scene, a projection image and a depth image that correspond to shooting from the camera position, and a camera position correcting unit corrects the camera position based on the depth image and a correspondence relationship between the query image and the projection image.

### CROSS-REFERENCE TO RELATED APPLICATION

This application is based upon and claims the benefit of priority from Japanese patent application No. 2023-128099, filed on Aug. 4, 2023, the disclosure of which is incorporated herein in its entirety by reference.

### BACKGROUND OF THE INVENTION

### 1. Field of the Invention

The present disclosure relates to an information processing apparatus, an information processing method, and a computer-readable recording medium for estimating a camera position.

### 2. Background Art

A technique is known for estimating three dimensional information of a camera from an image, in order to perform robot self-position estimation and three dimensional analysis on a subject. According to the technique, if internal parameters (e.g., focal length, lens distortion, etc.) of a camera and three dimensional coordinates of objects that constitute the shooting scene are both known, a rotation matrix and a translation vector of the camera can be estimated. In the following description, the rotation matrix and the translation vector of a camera are collectively referred to as a camera position.

One method of estimating a camera position from an image is to solve a PnP (Perspective-n-point) problem. In order to solve the PnP problem, a 3D point cloud of a scene is acquired using a 3D (3 dimensional) scanner, in advance. Next, feature points are calculated from an image obtained by shooting the scene with a camera, and corresponding 3D points (2D-3D corresponding points) are determined. Finally, the camera position is estimated by solving the PnP problem using the plurality of determined 2D-3D corresponding points. Patent Document 1 (International Publication No. WO/2012/157342) describes a method of obtaining a global optimum solution of a PnP problem.

With a conventional camera position estimation method, it is difficult to stably and accurately estimate a camera position when the illumination condition changes or a large error is included in 3D points. Note that, with the method described in Patent Document 1, the camera position may not be accurately estimated.

### SUMMARY OF THE INVENTION

An example object of the present disclosure is to accurately calculate a camera position.

In order to achieve the example object described above, an information processing apparatus according to an example aspect includes:
an image generating unit that generates, based on a camera position of a query image that is obtained by shooting a scene with a camera from the camera position, and three dimensional information regarding the scene, a projection image and a depth image that correspond to shooting from the camera position; and
a camera position correcting unit that corrects the camera position based on the depth image and a correspondence relationship between the query image and the projection image.

Also, in order to achieve the example object described above, an information processing method that is performed by an information processing apparatus according to an example aspect includes:
generating, based on a camera position of a query image that is obtained by shooting a scene by a camera from the camera position, and three dimensional information regarding the scene, a projection image and a depth image that correspond to shooting from the camera position; and
correcting the camera position based on the depth image and a correspondence relationship between the query image and the projection image.

Furthermore, in order to achieve the example object described above, a computer-readable recording medium according to an example aspect includes a program recorded on the computer-readable recording medium, the program including instructions that cause the computer to carry out:
generating, based on a camera position of a query image that is obtained by shooting a scene by a camera from the camera position, and three dimensional information regarding the scene, a projection image and a depth image that correspond to shooting from the camera position; and
correcting the camera position based on the depth image and a correspondence relationship between the query image and the projection image.

According to the present disclosure, the camera position can be accurately calculated.

### BRIEF DESCRIPTION OF THE DRAWINGS

FIG. 1 is a diagram for describing an example of the information processing apparatus.

FIG. 2 is a diagram for describing an example of a system including the information processing apparatus.

FIG. 3 is a diagram for describing an example of training of the depth image correction model.

FIG. 4 is a diagram for describing an example of the operations of the information processing apparatus.

FIG. 5 is a diagram for describing modification 1.

FIG. 6 is a diagram for describing an example of a computer that realizes the information processing apparatus in the example embodiment and the modification 1.

### EXEMPLARY EMBODIMENT

Hereinafter, an example embodiment will be described with reference to the drawings. Note that, in the drawings described below, the elements that have the same or corresponding functions are given the same reference numerals and description thereof may not be repeated.

### EXAMPLE EMBODIMENT

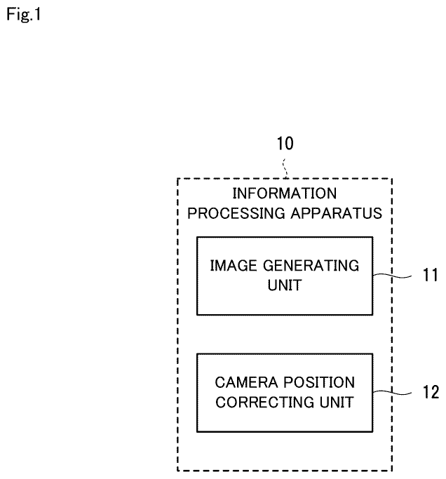

The configuration of an information processing apparatus will be described using FIG. 1. FIG. 1 is a diagram for describing an example of the information processing apparatus.

### [Apparatus Configuration]

The information processing apparatus shown in FIG. 1 is an apparatus for accurately calculating a camera position (rotation matrix and translation vector). Also, as shown in FIG. 1, the information processing apparatus 10 includes an image generating unit 11 and a camera position correcting unit 12.

The image generating unit 11 generates, based on a camera position of a query image obtained by shooting a scene with the camera from the camera position and three dimensional information regarding the scene, a projection image and a depth image corresponding to shooting from the camera position.

The camera position is information representing a rotation matrix and a translation vector of the camera estimated using internal parameters (e.g., focal length, lens distortion, etc.) of the camera and three dimensional coordinates of objects constituting the scene.

The query image is an image obtained by shooting a scene with the camera, and is an input image to be used for estimating the camera position. The input image may be a color image represented by RGB values, or may also be a gray scale image represented only by luminance values.

The three dimensional information is implicit function three dimensional information, for example. The implicit function three dimensional information is information representing three dimensions using a nonlinear implicit function such as NeRF (Neural Radiance Fields) or SRN (Scene Representation Network), for example. Also, the three dimensional information has the same color representation (RGB or gray scale) as the query image, in addition to the three dimensional shape information regarding the scene.

The camera position correcting unit 12 corrects the camera position based on the depth image and a correspondence relationship between the query image and the projection image.

As described above, in the example embodiment, the camera position is corrected using the corrected depth image, and therefore the camera position can be accurately calculated.

### [System Configuration]

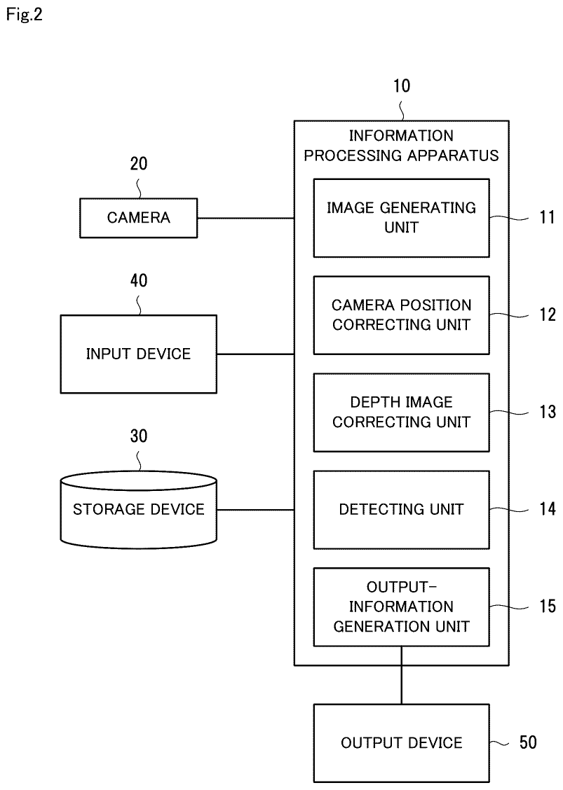

Next, the configuration of the information processing apparatus 10 of the example embodiment will be more specifically described using FIG. 2. FIG. 2 is a diagram for describing an example of a system including the information processing apparatus.

As shown in FIG. 2, the system 100 in the example embodiment includes the information processing apparatus 10, a camera 20, and a storage device 30. The camera (image capturing device) 20, the storage device 30, an input device 40, and an output device 50 are electrically connected to the information processing apparatus 10 by a network.

The network is an ordinary communication network constructed using a communication line such as the Internet, a LAN (Local Area Network), a dedicated line, a telephone line, an intranet, a mobile communication network, Bluetooth (registered trademark), or WiFi (Wireless Fidelity) (registered trademark), for example.

The information processing apparatus 10 is a CPU (Central Processing Unit), a programmable device such as an FPGA (Field-Programmable Gate Array), or a GPU (Graphics Processing Unit), or a circuit on which at least one of the devices is mounted, or an information processing apparatus such as a server computer, a personal computer, or a mobile terminal.

The camera 20 outputs images captured in time series to the information processing apparatus 10. A monocular camera (e.g., wide angle camera, fish-eye camera, omnidirectional camera, etc.), a compound eye camera (e.g., stereo camera, multi-camera, etc.), an RGB-D camera (e.g., depth camera, ToF camera, etc.), and the like are conceivable as the camera 20. Note that the camera 20 may also be provided in the information processing apparatus 10.

The storage device 30 is a database, a server computer, a circuit including a memory, or the like. In the example in FIG. 2, the storage device 30 is provided outside the information processing apparatus 10, but may also be provided inside the information processing apparatus 10.

The input device 40 includes devices (user interfaces) such as a touch panel, a mouse, and a keyboard, for example. Note that the input device 40 may also be provided in the information processing apparatus 10.

The output device 50 acquires later-described output information that has been converted into a format that can be output, and outputs images, audio and the like generated based on this output information. The output device 50 is an image display device that uses liquid crystal, organic EL (ElectroLuminescence), or a CRT (Cathode Ray Tube). Furthermore, the image display device may include an audio output device such as a speaker, and the like. Note that the output device 50 may also be a printing device such as a printer. Note that the output device 50 may also be provided in the information processing apparatus 10.

The information processing apparatus will be described in detail.

The information processing apparatus 10 includes an image generating unit 11, a camera position correcting unit 12, a depth image correcting unit 13, a detecting unit 14, and an output information generating unit 15.

The image generating unit 11 generates, using a camera position initial value indicating an initial state of the camera position of a query image and three dimensional information regarding a scene captured by the camera, a projection image and a depth image by projecting the three dimensional information on an image plane based on the camera position.

The camera position initial value may be a random rotation matrix and a random translation vector, or the origin of a three dimensional coordinate system of the scene.

Also, a known method such as VLAD (Locally Aggregated Descriptor) or BoW (Bag of word) may also be used, in order to automatically obtain the camera position as accurately as possible.

The projection image is an image obtained by projecting three dimensional information on an image plane of the camera based on the input camera position. Note that the projection image has the same color representation as the query image.

The depth image is an image in which each pixel has a depth value in a coordinate system whose origin is at the camera. Note that the depth value may be used as it is, or an inverse of the depth value may also be used.

Specifically, the image generating unit 11 first acquires, from the storage device 30, a camera position initial value of a query image for estimating the camera position, and three dimensional information regarding a scene captured by the camera. Next, the image generating unit 11 generates, using the camera position initial value and the three dimensional information, a projection image and a depth image by projecting the three dimensional information on the image plane based on the camera position.

The depth image correcting unit 13 corrects an error in the depth image by performing depth image correction processing using the projection image and the depth image.

Specifically, the depth image correcting unit 13 first acquires the projection image and the depth image. Next, the depth image correcting unit 13 corrects an error included in the depth image by performing the depth image correction processing using the projection image and the depth image.

The error is an inaccurate depth value occurring in the generated depth image, and may also be referred to as a so-called artifact.

The depth image correction processing is processing for correcting a depth image based on a projection image. Specifically, the depth image correction processing is processing for, using a neural network, for example, correcting a depth image using a depth image correction model for correcting an error included in the depth image.

Note that the depth image correction processing is not limited to the processing using a neural network, and may also be processing in which a machine learning method such as a support vector machine or a random forest is used. Also, the processing for correcting a depth image is not limited to a machine learning method, and may also be processing for performing correction according to a correction rule.

The depth image correction model is a machine learning model that receives a generated projection image and depth image as inputs, and outputs the projection image and depth image from both of which noise has been removed, or the depth image from which noise has been removed.

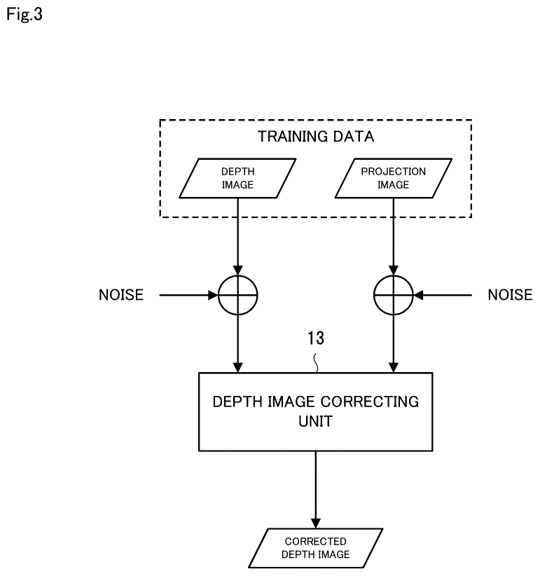

Training of the depth image correction model will be described using FIG. 3. FIG. 3 is a diagram for describing an example of training of the depth image correction model.

In the example in FIG. 3, first in the training, images of various scenes captured by the camera 20 in the past are acquired from the storage device 30. Next, noise is added to each scene image using computer graphics.

If the sensor noise distribution of the camera is known, the noise is a random value based on the distribution, and if the sensor noise distribution of the camera is not known, a random value based on Gaussian distribution is instead used as the noise.

Next, training data is obtained by generating a plurality of true value pairs of a projection image and a depth image to each of which noise is added. Next, supervised learning is executed by inputting a plurality of pieces of generated training data to the depth image correction model for removing noise from the projection image and depth image.

Note that computer graphics may not be used. For example, a plurality of projection images and depth images that have been subjected to learning with respect to various scenes using NeRF are generated, and correct answer pairs of the projection image and depth image corresponding to the respective scenes may also be generated.

The detecting unit 14 detects first image feature points included in the query image and second image feature points included in the projection image, and detects first corresponding points (2D-2D corresponding points: first corresponding point group) corresponding to both the first image feature points (first image feature point group) and the second image feature points (second image feature point group).

The 2D-2D corresponding point is information representing a matching pair of a first image feature point and a second image feature point. A method robust to illumination change such as SIFT (Scale Invariant Feature Transform) or SuperPoint is used as the method of acquiring the 2D-2D corresponding point.

Note that the 2D-2D corresponding point may also be manually designated by a user. A method that accepts removal of an erroneous corresponding point, such as RANSAC (Random Sample Consensus) may also be used for acquisition.

Specifically, the detecting unit 14 first acquires a query image and a projection image. Next, the detecting unit 14 detects first image feature points included in the query image and second image feature points included in the projection image. Next, the detecting unit 14 detects 2D-2D corresponding points (first corresponding points) corresponding to both the detected first image feature points and second image feature points.

The camera position correcting unit 12 first acquires the corrected depth image and the 2D-2D corresponding points (first corresponding points). Next, the camera position correcting unit 12 calculates a correction value for correcting the camera position by performing camera position correction processing using the corrected depth image and the 2D-2D corresponding points.

In the camera position correction processing, first, 2D-3D corresponding points (second corresponding points: second corresponding point group) between the query image and the projection image is acquired using the corrected depth image and the 2D-2D corresponding points (first corresponding points). Specifically, the pixels of the projection image are respectively associated with the depth values of the pixels of the corrected depth image. That is, 2D-3D corresponding points between the query image and the projection image is obtained.

Next, the correction value is calculated by performing processing for solving a PnP (Perspective-n-point) problem using the 2D-3D corresponding points (second corresponding points). Specifically, the camera position of the query image in a camera coordinate system in which the projection image is at the origin is calculated using a known PnP problem solving method. Here, the calculated camera position is equivalent to the difference (correction value) in the camera position from the projection image to the query image. Therefore, when the correction value (difference) is small, the difference in the rotation matrix approaches a unit matrix, and the difference in the translation vector approaches a zero vector.

Next, if the correction value is larger than a preset threshold value, the camera position correcting unit 12 corrects the camera position using the correction value. Specifically, the camera position correcting unit 12 adds the correction value to a camera position initial value or the current camera position.

Next, the camera position correcting unit 12 outputs the corrected camera position to the image generating unit 11. In contrast, if the correction value is the threshold value or less, the corrected camera position is adopted. That is, the processing is repeated until the correction value becomes the threshold value or less.

The output information generating unit 15 generates output information for performing display in the output device 50 by combining at least one of three dimensional spatial representations of the query image, projection image, depth image, and camera position.

Thereafter, the output information generating unit 15 outputs the output information to the output device 50. Note that the output information generating unit 15 may not be provided in the information processing apparatus 10.

### [Apparatus Operations]

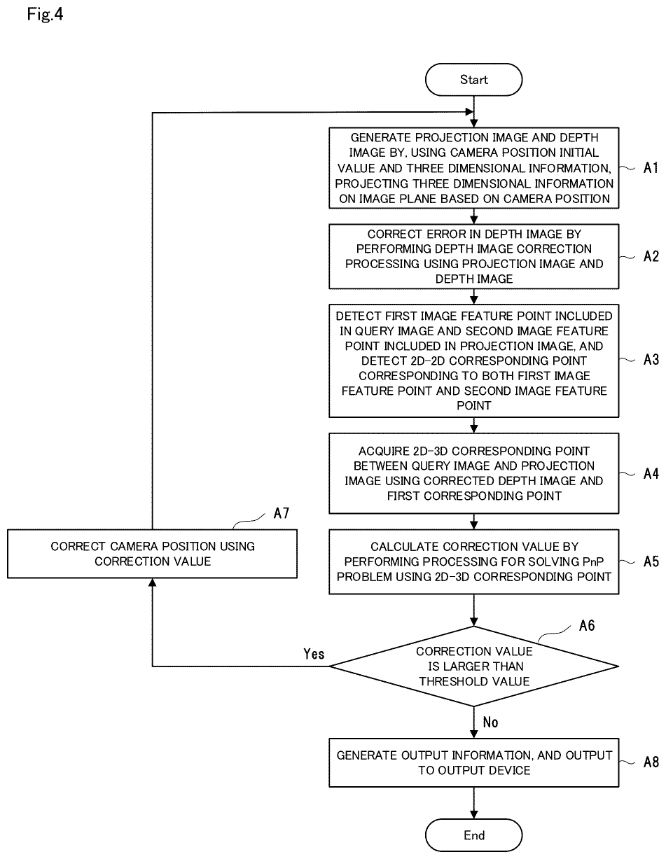

Next, operations of the information processing apparatus in the example embodiment will be described using FIG. 4. FIG. 4 is a diagram for describing an example of the operations of the information processing apparatus. In the following description, the diagrams are referred to as appropriate. Furthermore, in the example embodiment, an information processing method is implemented by causing the information processing apparatus to operate. Accordingly, the following description of the operations of the information processing apparatus substitutes for the description of the information processing method in the example embodiment.

As shown in FIG. 4, first, using a camera position initial value indicating an initial state of the camera position of a query image to be estimated and three dimensional information regarding the scene captured by the camera, a projection image and a depth image are generated by projecting the three dimensional information on an image plane based on the camera position (step A1).

Next, the depth image correcting unit 13 corrects an error in the depth image by performing depth image correction processing using the projection image and the depth image (step A2).

Next, the detecting unit 14 detects first image feature points included in the query image and second image feature points included in the projection image, and detects 2D-2D corresponding points (first corresponding points) corresponding to both the first image feature points and the second image feature points (step A3). Note that the processing order of step A2 and step A3 described above may be reversed.

Next, the camera position correcting unit 12 acquires 2D-3D corresponding points (second corresponding points) between the query image and the projection image using the corrected depth image and the first corresponding points (step A4).

Next, the camera position correcting unit 12 calculates a correction value by performing processing for solving a PnP problem using the 2D-3D corresponding points (step A5).

Next, the camera position correcting unit 12 determines whether or not the correction value is larger than a threshold value (step A6). If the correction value is larger than the threshold value (step A6: Yes), the camera position correcting unit 12 corrects the camera position using the correction value (step A7).

Specifically, in step A7, the camera position correcting unit 12 adds the correction value to the camera position initial value or the current camera position. Then, the processing from step A1 is executed again using the corrected camera position.

In contrast, if the correction value is the threshold value or less (step A6: No), the corrected camera position is adopted, and the processing is ended. Thereafter, the output information generating unit 15 generates output information, and outputs the generated output information to the output device 50 (step A8).

### Effects of Example Embodiment

As described above, according to the example embodiment, the camera position is corrected using the corrected depth image and the 2D-2D corresponding point, and therefore the camera position can be accurately calculated. Also, it is suitable for an application in which the camera position is estimated from an image.

### Modification 1

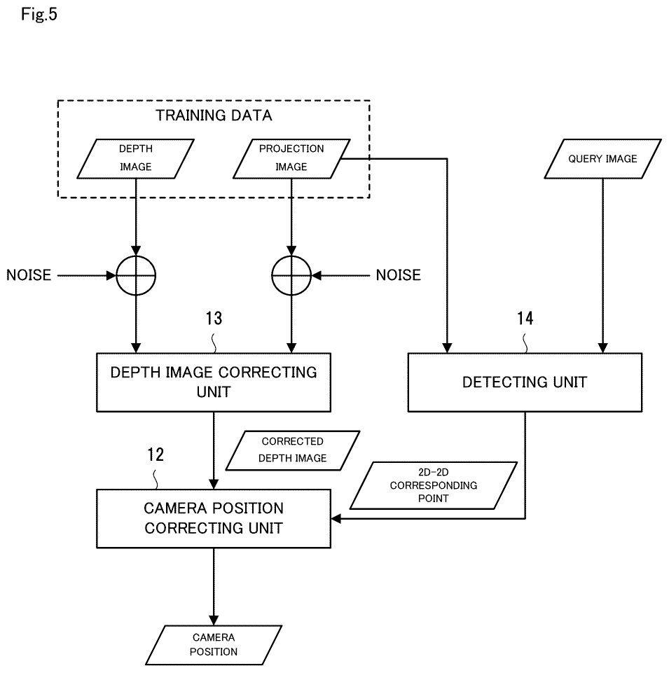

Modification 1 will be described using FIG. 5. FIG. 5 is a diagram for describing Modification 1. The aforementioned depth image correction model of the depth image correcting unit 13 was constructed by supervised learning using a neural network, but in Modification 1, the depth image correction model is constructed by performing learning using a neural network, in which true values of the depth image are not needed.

The depth image correction model of Modification 1 is a machine learning model that receives generated projection image and depth image as inputs, and outputs the projection image and depth image from both of which noise has been removed, or the depth image from which noise has been removed.

In the example in FIG. 5, machine learning may be performed in which data obtained by adding noise to a depth image and a projection image is input as input training data, and a correction value of the camera position of the camera position correcting unit 12 is output as training data. That is, the difference between the true value and the estimated value of the camera position is learnt by an error back-propagation method. Accordingly, the corrected depth image is implicitly learnt.

According to Modification 1, the true value of the depth image need not be generated in advance, and therefore real data obtained by shooting performed by a RGB-D sensor can be used for learning, in addition to simulation by computer graphics.

### [Program]

The program according to the second example embodiment may be a program that causes a computer to execute steps A1 to A8 shown in FIG. 4. By installing this program in a computer and executing the program, the information processing apparatus and the information processing method according to the second example embodiment can be realized. In this case, the processor of the computer performs processing to function as the image generating unit 11, the camera position correcting unit 12, the depth image correcting unit 13, the detecting unit 14, and the output information generating unit 15.

Also, the program according to the embodiment may be executed by a computer system constructed by a plurality of computers. In this case, for example, each computer may function as any of the image generating unit 11, the camera position correcting unit 12, the depth image correcting unit 13, the detecting unit 14, and the output information generating unit 15.

### [Physical Configuration]

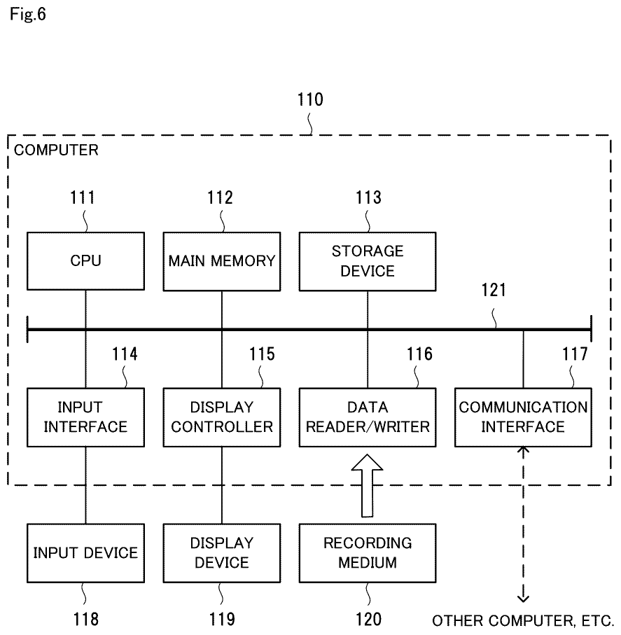

Here, a computer that realizes the information processing apparatus by executing the program according to the example embodiment and the modification 1 will be described with reference to FIG. 6. FIG. 6 is a diagram illustrating an example of a computer that realizes the information processing apparatus in the example embodiment and the modification 1.

As shown in FIG. 6, a computer 110 includes a CPU (Central Processing Unit) 111, a main memory 112, a storage device 113, an input interface 114, a display controller 115, a data reader/writer 116, and a communications interface 117. These units are each connected so as to be capable of performing data communications with each other through a bus 121. Note that the computer 110 may include a GPU (Graphics Processing Unit) or an FPGA (Field-Programmable Gate Array) in addition to the CPU 111 or in place of the CPU 111.

The CPU 111 opens the program (code) according to this example embodiment, which has been stored in the storage device 113, in the main memory 112 and performs various operations by executing the program in a predetermined order. The main memory 112 is typically a volatile storage device such as a DRAM (Dynamic Random Access Memory).

Also, the program according to the example embodiment and the modification 1 are provided in a state being stored in a computer-readable recording medium 120. Note that the program according to the example embodiment and the modification 1 may be distributed on the Internet, which is connected through the communications interface 117.

Also, other than a hard disk drive, a semiconductor storage device such as a flash memory can be given as a specific example of the storage device 113. The input interface 114 mediates data transmission between the CPU 111 and an input device 118, which may be a keyboard or mouse. The display controller 115 is connected to a display device 119, and controls display on the display device 119.

The data reader/writer 116 mediates data transmission between the CPU 111 and the recording medium 120, and executes reading of a program from the recording medium 120 and writing of processing results in the computer 110 to the recording medium 120. The communications interface 117 mediates data transmission between the CPU 111 and other computers.

Also, general-purpose semiconductor storage devices such as CF (Compact Flash (registered trademark)) and SD (Secure Digital), a magnetic recording medium such as a Flexible Disk, or an optical recording medium such as a CD-ROM (Compact Disk Read-Only Memory) can be given as specific examples of the recording medium 120.

The information processing apparatus 10 according to the example embodiment and the modification 1 can also be achieved using hardware corresponding to the components, instead of a computer in which a program is installed. Furthermore, a part of information processing apparatus 10 may be realized by a program and the remaining part may be realized by hardware. In the example embodiment and the modification 1, the computer is not limited to the computer shown in FIG. 6.

### [Supplementary Notes]

The following supplementary notes are also disclosed in relation to the above-described example embodiments. Although at least part or all of the above-described example embodiments can be expressed as, but are not limited to, (Supplementary note 1) to (Supplementary note 21) described below.

(Supplementary note 1)

An information processing apparatus comprising:
an image generating unit generates, based on a camera position of a query image that is obtained by shooting a scene with a camera from the camera position, and three dimensional information regarding the scene, a projection image and a depth image that correspond to shooting from the camera position; and
a camera position correcting unit corrects the camera position based on the depth image and a correspondence relationship between the query image and the projection image.
   (Supplementary note 2)

The information processing apparatus according to supplementary note 1, further comprising
a depth image correcting unit corrects an error in the depth image by performing depth image correction processing using the projection image and the depth image.
   (Supplementary note 3)

The information processing apparatus according to supplementary note 2,
wherein the depth image correction processing is processing in which a machine learning model is used that, upon receiving the projection image and the depth image as inputs, outputs a corrected depth image obtained by removing noise from the depth image, or both the corrected depth image and the projection image.
   (Supplementary note 4)

The information processing apparatus according to supplementary note 3,
wherein the machine learning model
   is for acquiring a corrected depth image by receiving training data obtained by adding noise to a depth image and a projection image as inputs, and
   is obtained by performing machine learning using, as output training data, a camera position correction value that does not include noise obtained by inputting the corrected depth image to the camera position correcting unit.
      (Supplementary note 5)

The information processing apparatus according to supplementary note 1, further comprising
a detecting unit detects first image feature points included in the query image and second image feature points included in the projection image, and detects first corresponding points corresponding to both the first image feature points and the second image feature points.
   (Supplementary note 6)

The information processing apparatus according to supplementary note 5,
wherein the camera position correcting unit
   acquires second corresponding points between the query image and the projection image using the corrected depth image and the first corresponding points corresponding to both the first image feature points and the second image feature points,
   calculates a correction value by performing processing for solving a PnP (Perspective-n-point) problem using the second corresponding points,
   if the correction value is larger than a preset threshold value, adds the correction value to an initial value of the camera position or a current camera position, and
   if the correction value is the threshold value or less, adopts a corrected camera position.
      (Supplementary note 7)

The information processing apparatus according to any one of supplementary notes 1 to 4,
wherein the three dimensional information is information representing the scene in three dimensions using a nonlinear implicit function.
   (Supplementary note 8)

An information processing method that is performed by an information processing apparatus, the method comprising:
generating, based on a camera position of a query image that is obtained by shooting a scene by a camera from the camera position, and three dimensional information regarding the scene, a projection image and a depth image that correspond to shooting from the camera position; and
correcting the camera position based on the depth image and a correspondence relationship between the query image and the projection image.
   (Supplementary note 9)

The information processing method according to supplementary note 8,
wherein the information processing apparatus
   correcting an error in the depth image by performing depth image correction processing using the projection image and the depth image.
      (Supplementary note 10)

The information processing method according to supplementary note 9,
wherein the depth image correction processing is processing in which a machine learning model is used that, upon receiving the projection image and the depth image as inputs, outputs a corrected depth image obtained by removing noise from the depth image, or both the corrected depth image and the projection image.
   (Supplementary note 11)

The information processing method according to supplementary note 10,
wherein the machine learning model
   is for acquiring a corrected depth image by receiving training data obtained by adding noise to a depth image and a projection image as inputs, and
   is obtained by performing machine learning using, as output training data, a camera position correction value that does not include noise obtained by inputting the corrected depth image.
      (Supplementary note 12)

The information processing method according to supplementary note 8,
wherein the information processing apparatus
   detecting first image feature points included in the query image and second image feature points included in the projection image, and detect first corresponding points corresponding to both the first image feature points and the second image feature points.
      (Supplementary note 13)

The information processing method according to supplementary note 12,
wherein the information processing apparatus
   acquiring second corresponding points between the query image and the projection image using the corrected depth image and the first corresponding points corresponding to both the first image feature points and the second image feature points,
   calculating a correction value by performing processing for solving a PnP (Perspective-n-point) problem using the second corresponding points,
   if the correction value is larger than a preset threshold value, adding the correction value to an initial value of the camera position or a current camera position, and
   if the correction value is the threshold value or less, adopting a corrected camera position.
      (Supplementary note 14)

The information processing method according to any one of supplementary notes 8 to 11, wherein the three dimensional information is information representing the scene in three dimensions using a nonlinear implicit function.

(Supplementary note 15)

A computer-readable recording medium that includes a program including instructions recorded thereon, the instructions causing a computer to carry out:
generating, based on a camera position of a query image that is obtained by shooting a scene by a camera from the camera position, and three dimensional information regarding the scene, a projection image and a depth image that correspond to shooting from the camera position; and
correcting the camera position based on the depth image and a correspondence relationship between the query image and the projection image.
   (Supplementary note 16)

The computer readable recording medium according to supplementary note 15,
wherein the program causes the computer to carry out:
   correcting an error in the depth image by performing depth image correction processing using the projection image and the depth image.
      (Supplementary note 17)

The computer readable recording medium according to supplementary note 16,
wherein the depth image correction processing is processing in which a machine learning model is used that, upon receiving the projection image and the depth image as inputs, outputs a corrected depth image obtained by removing noise from the depth image, or both the corrected depth image and the projection image.
   (Supplementary note 18)

The computer readable recording medium according to supplementary note 17,
wherein the machine learning model
   is for acquiring a corrected depth image by receiving training data obtained by adding noise to a depth image and a projection image as inputs, and
   is obtained by performing machine learning using, as output training data, a camera position correction value that does not include noise obtained by inputting the corrected depth image.
      (Supplementary note 19)

The computer readable recording medium according to supplementary note 15,
wherein the program causes the computer to carry out:
   detecting first image feature points included in the query image and second image feature points included in the projection image, and detect first corresponding points corresponding to both the first image feature points and the second image feature points.
      (Supplementary note 20)

The computer readable recording medium according to supplementary note 19,
wherein the program causes the computer to carry out:
   acquiring second corresponding points between the query image and the projection image using the corrected depth image and the first corresponding points corresponding to both the first image feature points and the second image feature points,
   calculating a correction value by performing processing for solving a PnP (Perspective-n-point) problem using the second corresponding points,
   if the correction value is larger than a preset threshold value, adding the correction value to an initial value of the camera position or a current camera position, and
   if the correction value is the threshold value or less, adopting a corrected camera position.
      (Supplementary note 21)

The computer readable recording medium according to any one of supplementary notes 15 to 18,
wherein the three dimensional information is information representing the scene in three dimensions using a nonlinear implicit function.

Although the invention has been described with reference to the example embodiment and the modification 1, the invention is not limited to the example embodiment and the modification 1 described above. Various changes can be made to the configuration and details of the invention that can be understood by a person skilled in the art within the scope of the invention.

### INDUSTRIAL APPLICABILITY

According to the describe above, the camera position can be accurately calculated. In addition, it is useful in a field where camera position calculation is required.

While the invention has been particularly shown and described with reference to exemplary example embodiments thereof, the invention is not limited to these example embodiments. It will be understood by those of ordinary skill in the art that various changes in form and details may be made therein without departing from the spirit and scope of the present invention as defined by the claims.

What is claimed is:

1. An information processing apparatus comprising:
at least one memory storing instructions; and
at least one processor configured to execute the instructions to:
generate, based on a camera position of a query image that is obtained by shooting a scene with a camera from the camera position, and three dimensional information regarding the scene, a projection image and a depth image that correspond to shooting from the camera position; and
correct the camera position based on the depth image and a correspondence relationship between the query image and the projection image.

2. The information processing apparatus according to claim 1,
wherein the one or more processors further:
corrects an error in the depth image by performing depth image correction processing using the projection image and the depth image.

3. The information processing apparatus according to claim 2, wherein
the depth image correction processing is processing in which a machine learning model is used that, upon receiving the projection image and the depth image as inputs, outputs a corrected depth image obtained by removing noise from the depth image, or both the corrected depth image and the projection image.

4. The information processing apparatus according to claim 3, wherein
the machine learning model
is for acquiring a corrected depth image by receiving training data obtained by adding noise to a depth image and a projection image as inputs, and
is obtained by performing machine learning using, as output training data, a camera position correction value that does not include noise obtained by inputting the corrected depth image.

5. The information processing apparatus according to claim 1,
wherein the one or more processors further:
detects first image feature points included in the query image and second image feature points included in the projection image, and detect first corresponding points corresponding to both the first image feature points and the second image feature points.

6. The information processing apparatus according to claim 5,
wherein the one or more processors further:
acquires second corresponding points between the query image and the projection image using the corrected depth image and the first corresponding points corresponding to both the first image feature points and the second image feature points,
calculates a correction value by performing processing for solving a PnP (Perspective-n-point) problem using the second corresponding points,
if the correction value is larger than a preset threshold value, adds the correction value to an initial value of the camera position or a current camera position, and
if the correction value is the threshold value or less, adopts a corrected camera position.

7. The information processing apparatus according to claim 1, wherein
the three dimensional information is information representing the scene in three dimensions using a nonlinear implicit function.

8. An information processing method, comprising:
an information processing apparatus
generating, based on a camera position of a query image that is obtained by shooting a scene by a camera from the camera position, and three dimensional information regarding the scene, a projection image and a depth image that correspond to shooting from the camera position; and
correcting the camera position based on the depth image and a correspondence relationship between the query image and the projection image.

9. A non-transitory computer-readable recording medium that includes a program including instructions recorded thereon, the instructions causing a computer to carry out:
generating, based on a camera position of a query image that is obtained by shooting a scene by a camera from the camera position, and three dimensional information regarding the scene, a projection image and a depth image that correspond to shooting from the camera position; and
correcting the camera position based on the depth image and a correspondence relationship between the query image and the projection image.
